(19) United States
(12) Patent Application Publication
(10) Pub. No.: US 2012/0238360 A1
(43) Pub. Date: Sep. 20, 2012

(54) Video match game

(76) Inventor: Vladimir Grigorievich Pirogov, Moscow (RU)

(21) Appl. No.: 13/065,249

(22) Filed: Mar. 18, 2011

(51) Int. Cl. A63F 13/00

(52) U.S. Cl. 463/31

(57) ABSTRACT

The methods of the difficult, medium and easy versions of a video game and a computer game program for processing a video game are disclosed. On an image display screen of an image display apparatus, machine or device for a video game is consistently displayed a set of the different images one after another. When one of said images is displayed on said image display screen repeatedly a player should react, for example, pushing some button, key, etc. To control the game it's enough to use, for example, 2-3 said buttons. If a player has guessed rightly that the image was already displayed, he or she has won. The same video game program may be embodied for different categories of players: children, adults, men, women, etc., changing only a database. The present invention may be applied to a video game apparatus or machine, a personal computer, a cellular phone terminal, a portable game device, or the like.

### REFERENCES CITED [REFERENCED BY]

### U.S. Patent Documents

U.S. Pat. No. 3,584,398 May 1871 Meyer et al.

U.S. Pat. No. 4,498,869 February 1985 Faison

U.S. Pat. No. 5,411,271 May 1995 Mirando

U.S. Pat. No. 5,630,753 May 1997 Fuchs

U.S. Pat. No. 5,816,915 October 1998 Kadlic

U.S. Pat. No. 5,823,873 October 1998 Moody

U.S. Pat. No. 6,287,197 September 2001 Dickinson et al.

### OTHER REFERENCES

V. G. Pirogov, USA Copyright Office, “Author's Description of New Type of Game for Entertaining Programs, Devices, etc.”, May 31 2005, PAU 2-879-540.

### BACKGROUND OF THE INVENTION

1. Field of the Invention

The present invention relates to the memory game for matching images, displayed on the image display screen, with the image, displayed earlier on said screen.

2. Description of Related Art

Previous technological devices and games which demand that a player compared responses with visual helps, are described in the U.S. Pat. Nos. 3,978,302; 4,829,431 and 5,122,062.

Some prior art educational devices and games include a timing mechanism to test the user's skill in a shortened time frame. The following patents disclose such devices, even though they are known in other contexts: U.S. Pat. Nos. 3,710,455; 4,593,904 and 5,178,545.

Finally, the following U.S. Pat. Nos are cited as being of general interest, but otherwise do not appear to be as relevant to the disclosed invention: U.S. Pat. Nos. 2,835,052; 4,508,353; 5,411,271; 6,287,197; 7,690,992. Part of the concept of the video game was described in a work of the author of this invention: “Author's Description of New Type of Game for Entertaining Programs, Devices, etc.”, May 31 2005, PAU 2-879-540, Copyright Office.

### SUMMARY OF THE INVENTION

The present invention comprises an entertaining video match game method for an apparatus, a machine or a device for entertainment which displays a set of the images, in which a player is challenged to match the image previously displayed on an image display screen with the image, displayed repeatedly, as a rule, within a short time interval. The present invention comprises the method for a video match game device, in which the player is challenged to match the image—ORIGINAL, previously displayed on a screen. Each said image of video game is understood one static image or a group of the static images making the dynamic image, for example, an animation character. The images are stored in a memory unit, for example, in a database coupled to a control section. The sequence of the displayed images is defined according to a game program and a display set. An initial set may be converted in a few display sets and used in several different games. Video game makes a player to find a match an image to the ORIGINAL out of the several responses—the images of a display set. In a difficult game version all images of a display set are displayed on an image display screen in the similar way, not allocating anybody. In other versions a player may, at least, to divide a display set mentally in two parts—the original(s) and responses—by means of the game program help(s) or by counting (1, 2, . . . ).

When the same image is displayed on an image display screen the second time, a player through input section should signal about that a control section by pushing, for example, some button of a touch-screen, keyboard, etc.

A relative division of the game versions into three levels may be only considered at an observance of other equal conditions.

For example, if an initial set consists of four single-element images, for example, a doll, a cube, an apple and a young animal, the child may win, using even a difficult version of a game.

If an initial set consists of ten static images, each of which consisting of ten separate elements of the different shapes and colors, even if the easiest version of a video game is used, hardly will a player win.

Creation of an initial set for adults, for example, out of twelve fragments of some picture isn't a difficult problem. Such initial set will give twelve different game versions.

### BRIEF DESCRIPTION OF THE DRAWINGS

The features and advantages of the present invention will become more obvious from the following detailed description of the exclusive embodiments of the present invention with the reference to the appending drawings.

FIG. 1 is a block diagram that illustrates an example of a configuration of a video game 100 to which an embodiment of the present invention is applied.

FIG. 2 is a flowchart that illustrates an example of the main process of video game 100 to which an embodiment of the present invention is applied.

FIG. 3 is an example of an initial set out of four different images of the present invention.

FIG. 4 is an example of a display set out of five images, which is formed out of an initial set of FIG. 3 of the present invention.

FIG. 5 is an example of displaying of an image display screen during the display of each image of the display set in difficult and easy versions of the present invention.

FIG. 6 is an example of displaying of an image display screen in case a player chooses the right response.

FIG. 7 is an example of the demonstration of an image display screen in case a player chooses one of the incorrect responses.

FIG. 8 is an example of the demonstration of an image display screen during displaying of each image of the display set in the medium version of the present invention.

### DETAILED DESCRIPTION OF THE INVENTION

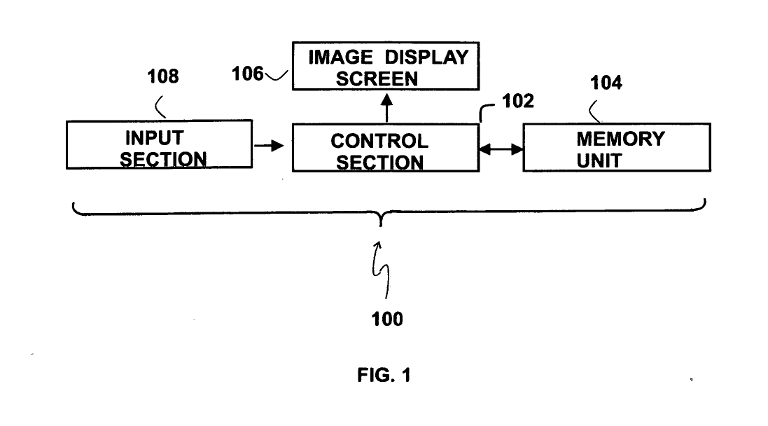

Preferred embodiments of a video game method and a game program product for processing a video game according to the present invention will be described in detail with reference to the appending drawings. FIG. 1 is a block diagram that illustrates an example of a configuration of a video game 100 to which an embodiment of the present invention is applied. The video game 100 may comprise virtually any type and/or size of video game, including, for example, wagering video games, portable video games, microprocessor or PC-driven video games. Video game 100 includes control section 102 coupled to a memory unit 104, to an image display screen 106, and to an input section 108.

Control section 102 may comprise a microcomputer, microprocessor or any other suitable device known in the art. A memory unit 104 may consist of one or more different structures of memory: HDD hard disk, DVD-ROM compact disc, flash card or any other storage media known in the art. A memory unit 104 stores a game program, a database, a score and other data associated with the video game 100. A score memory contains an account information, including, the high results received in the previous games of a video game. An image display screen 106 may include the liquid crystal monitor, matrix, or any other type of the display known in the art. An input section 108—operator interface—may comprise a few push buttons, joystick, keyboard, touch-screen or the like.

A control section 102 executes control of an apparatus, machine or device of video game 100 in accordance with game program, to a player's parameter identifications and input signals, communicates the resulting video game play activity, for example, by a text, animation, sound and/or the like functions. However, those skilled in the art will recognize that any device, capable of generating or reproducing an image may be used without departing from the scope or spirit of the present invention.

Explanations for any process other than the processes relating to the present invention are omitted.

There are difficult, medium and easy versions of an embodiment of the present invention and, hence, three or more levels of difficulty. In the description a difficult level of a video game first of all is connected with a location of the ORIGINAL in a display set, therefore it is the first parameter of a game. In the difficult version of a game it is necessary for a player to remember all images till the moment when one of the displayed images will appear on a screen for the second time. Other parameters of a game may also be selected by a player or are used by default.

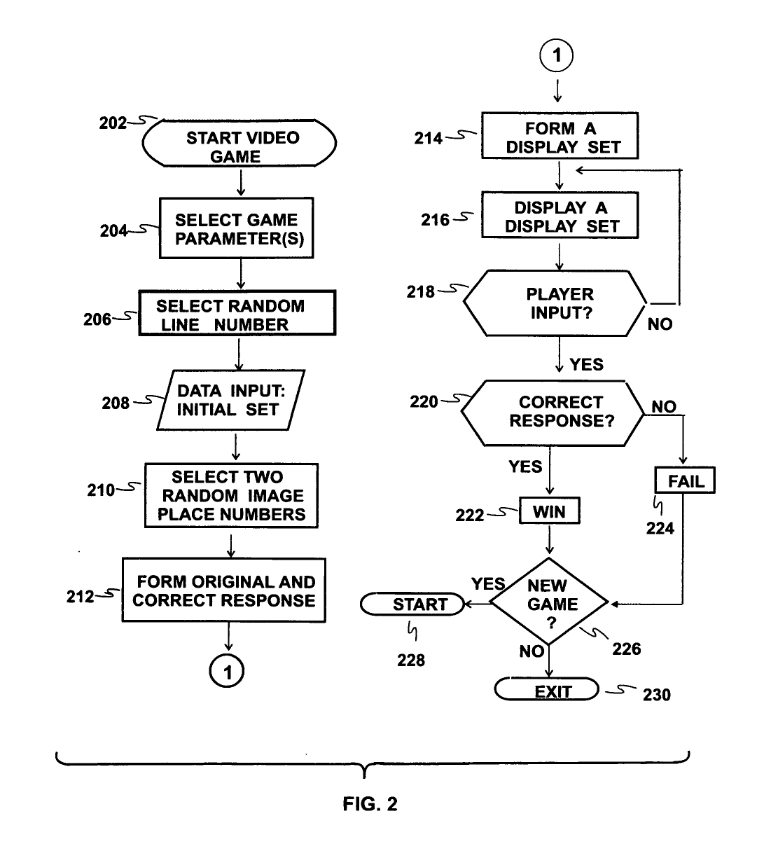

FIG. 2 is a flowchart that illustrates an example of a main process of video game 100 according to the present embodiment. Parameters of a game may be selected by the manufacturer of a game and are used by default.

In accordance with the first aspect of the present invention, there is provided a main process of a difficult version a video game, illustrated in FIG. 2. Video game is caused at step 202, using the predetermined parameters of a game according to a game program. These parameters may be stored in a memory unit 104 or are selected by a player partially or completely.

The first parameter of the difficult game version: the ORIGINAL may be located at any place of an initial set and may have the same place number in a display set. This and other parameters of a game may be used by default or selected by a player at step 204.

The other parameters of a game may be: the image number of an initial set, the time interval of demonstration of each image or their manual operation, the player's category, etc. The category of a player may be included on a structure of parameters if representatives of different categories use a video game, for example, a child and an adult, or a man and a woman. In this case it is possible the use of the access code to a game to the separate categories. For each category of the players it is desirable to prepare the special initial sets on the specific themes.

For men, for example, the flowers, fragments of the pictures, cars, beautiful women may be prepared as the themes; for children the fruits, toys, flowers, young animals may be the themes.

For the game parameters setting one of the known systems may be used and, hence, it is not described in detail.

At step 206 a game program chooses a random digit—a database line number if a database consists of two or more lines. Out of such lines a group may be formed, which may permanently input as one line, increasing a version game number.

At step 208 a game program inputs a line under said number of step 206 as an initial set of a game. An initial set consists of two or more different images. Each image of an initial set has a place number, designated, for example, by digits 1, 2, 3, etc. The maximum number of the images is defined by the manufacturer of a game, for example, twelve. In said example, with a view of simplifying the description this parameter—four images—is selected.

The same number may be practically selected, for example, for the category—CHILDREN. An initial set of said example consists of the images with digits: 302, 304, 306, 308 and with the place numbers 1-4 (FIG. 3).

To display on an image display screen a game program makes up a display set out of the initial set images. A display set has one place more than an initial set. In said example it has 4+1=5 places.

At step 210 (FIG. 2) a game program randomly selects two different digits or other figures—the place numbers out of all place numbers of a display set.

In said example a game program selected digits “4” and “2” out of the digits 1-5. Out of two different digits of step 210 a game program selects the smaller and bigger digits. In said example out of two digits of step 210—“4” and “2”—the smaller digit is “2”.

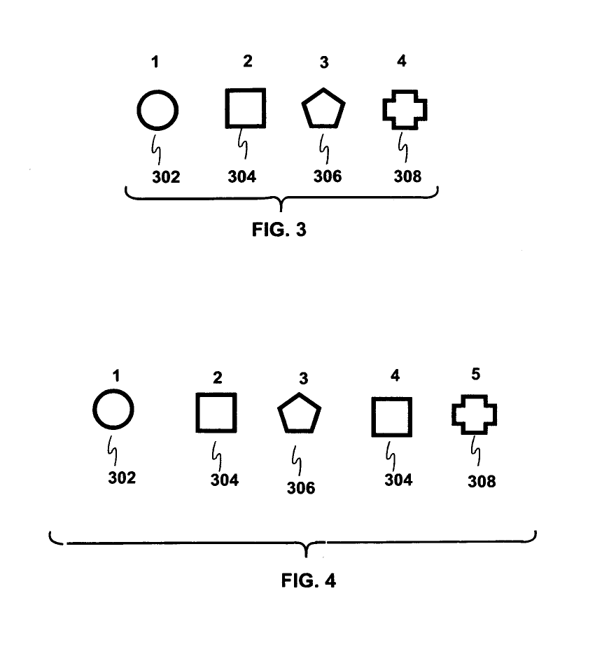

At step 212 in the place of an initial set with the smaller digit there is an image with the name the ORIGINAL. In said example in an initial set in place “2” there is an image 304—a square (FIG. 3). An image 304 becomes the ORIGINAL of a display set with the same place number. In said example it's a place number—“2” (FIG. 4).

In another place of a display set we'll call the ORIGINAL as the RIGHT RESPONSE, the place is defined by a bigger digit of step 210. In said example it's digit “4”. The RIGHT RESPONSE—304—a square—takes place “4” of a display set and image 308 becomes a non-used image of an initial set.

At step 214 a game program completes forming a display set, defining the place numbers in a display set for the non-used images of an initial set. In said example place “1”—image 302—and place “3”—image 306 of an initial set become the non-used images.

These images may remain under the same numbers and in a display set. If the bigger digit of step 210 is within the limits of an initial set, the image which is in this place can be transferred to the last place of a display set. In said example image 308 at place “4” of an initial set is transferred to the last place “5” of a display set. If the bigger digit of step 210 is out of the limits of an initial set, then all non-used images of this set may remain under the same numbers in a display set.

There is another principle to locate the non-used images of an initial set in the empty places of a display set is possible.

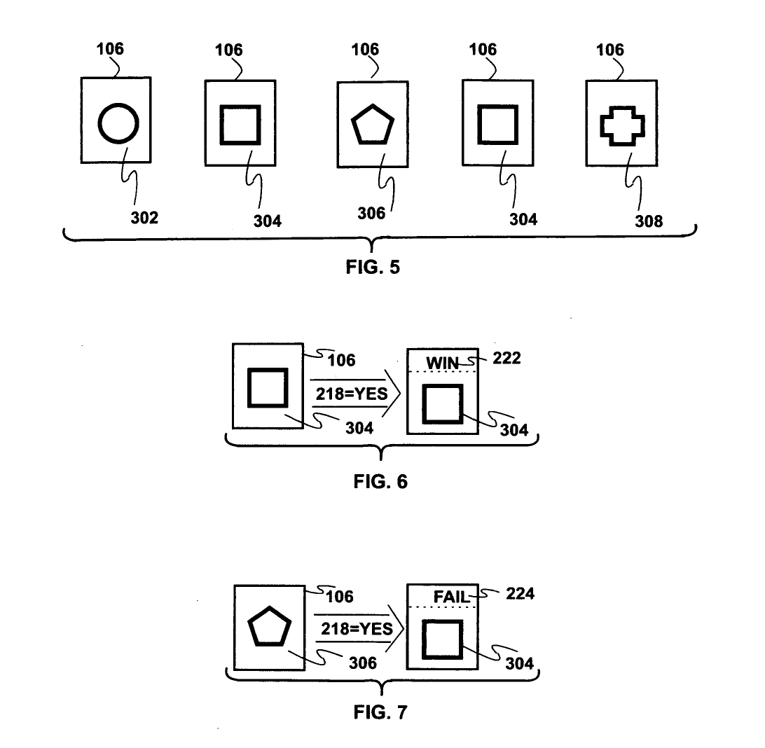

For example, three non-used images—302, 306 and 308—may be distributed at random in three empty places 1, 3, 5 of a display set. At step 216 (FIG. 2) on an image display screen 106 (FIG. 1) a game program displays a display set, one image after another (FIG. 5) with an equal interval or by means of manual operation, according to the selected parameters of a game.

At step 218, when one of the images of a display set is displayed on an image display screen the second time, a player should react, pushing, for example, some button of an input section 108, i.e. sending some signal to control section 102 of the video game 100 (FIG. 1).

At step 220 the game program compares an image matched by a player with the RIGHT RESPONSE that is defined by a game program at step 212, or compares their place numbers in a display set. If both images are identical, making a pair or their numbers are equal, it's a win—step 222, and the illustration in FIG. 6.

If images or their numbers are different, it's a fail—step 224, and the illustration in FIG. 7.

Control section 102 informs a player about the results of a game by the video or/and sound fragments, various texts, labels, etc.

For example, in FIGS. 6 and 7 a control section informs accordingly WIN and FAIL.

At step 226 a choice is given to a player: to start a new game—step 228, or to exit a game—step 230.

In a difficult version a player does not know, what image is the ORIGINAL and should remember all displayed images till the moment when the RIGHT RESPONSE appears, that makes this version of a game the most difficult of all said versions with other things being equal. In the difficult game version an embodiment of a database of the display sets is possible. In contrast to an initial set a display set may be only used for the concrete group of the game parameters.

If in such display set to give a place number of the ORIGINAL or the RIGHT RESPONSE, embodiment the present invention in a compact video game device is possible because of the steps 210, 212 and 214, to form a display set, are excluded.

In accordance with the second aspect of the present invention, the main process of the easy game version is provided in FIG. 2.

The first parameter of an easy game version at step 204 (FIG. 2): the ORIGINAL must be located in the first place of a display set. This and other parameters of a game may be used by default or selected by a player at step 204.

Steps 206, 208 and 210 remain the same as in a difficult game version. At step 212 in a place of an initial set with smaller figure, as well as in the difficult game version, there is the ORIGINAL, but the ORIGINAL is always given the first place in a display set.

The steps 214-230 remain the same as in the difficult game version. Using an easy game version, a player knows that the first image the display set is always the ORIGINAL and should only remember one image till the moment of the next demonstration of this image what makes this game version the the easiest with other things being equal. In the easy game version an embodiment of a database of the display sets for the concrete group of the game parameters is possible.

In accordance with the third aspect of the present invention, the main process of the medium game version is provided in FIG. 2.

The first parameter of the medium game version at step 202: the ORIGINAL must be located in one of two or more initial places of a display set and the number of the initial places is selected by a player or is used by default at step 204.

Other parameters of a game may be also selected by a player or are used by default at step 204.

The steps 206, 208 and 210 remain the same as in the other game versions.

At step 212, as in the previous versions, the ORIGINAL and the RIGHT RESPONSE places are defined, and for definition of the ORIGINAL place in the display set the random selection from all initial places of the display set is necessary. In said example a player has selected as an parameter two initial places, i.e. the place numbers “1” and “2” out of which a game program has randomly chosen a digit “1”.

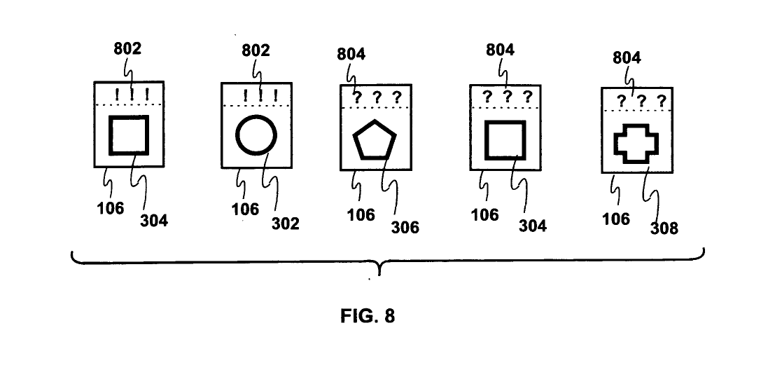

To win, a player should remember two initial images (in the example—the square and a circle) out of which only one image will be repeated the second time—in an example has appeared a square in the fourth place of a display set. (FIG. 8).

In FIG. 8 while displaying the initial images 304 and 302, the exclamation marks 802 are simultaneously displayed as the helps. During displaying the responses the question marks 804 are simultaneously displayed as the helps, though it is possible to refuse displaying the second group of the signs (helps).

Steps 214-230 remain the same, as in the other game versions. In a medium game version a player should remember the number of the initial images selected by him or her as the initial place number. If a display set, for example, consists of thirteen images out of which six initial images, to count to six and simultaneously to remember six different images is very difficult. In this case it is possible to use a help. In said example only two initial images were selected and counting 1, 2 doesn't cause an additional difficulty.

In this case it is possible to reject the both helps 802 and 804 or only help 804 (FIG. 8).

While the invention has been described with reference to the preferred embodiments thereof, modifications or changes may be made to the methods and structure of the game without departing from the spirit and scope thereof.

The present invention can be applied to a video game apparatus or a machine, a personal computer, a cellular phone terminal, a portable videogame device or the like.

What is claimed is:

1. A method of video game comprises the steps of:
(a) selecting or using by default the first game parameter: the original may be at any place of a display set except the last place, the original is an image which is located on two different places of a display set, the original at the second place we'll call the right response;
(b) selecting or using by default the other game parameters: an image number of a display set, the time interval of displaying each image at an image display screen or their manual operation, a category of a player if the method is intended to be used by the different categories of players, etc.;
(c) random selection of a line database number if a database consists of two or more lines;
(d) data input—two or more different images, which compose an initial set, using a line database number, defined at step (c), an initial set is a basic set for forming a number of display sets and has one image less then a display set, because it doesn't contain the same images, if a database consists of one line then such line may contain one or more initial sets;
(e) random selection of two different place numbers out of all place numbers of a display set, having in mind that out of two different digits or other figures, one is smaller, the other is bigger;
(f) assigning the name the original to an image of an initial set, which is located on a smaller place number, defined at step (e), for using the same place number and name in a display set;
(g) assigning the bigger place number, defined at step (e), as a place number of the right response of a display set;
(h) final formation of a display set, filling the empty places by the non-used images of an initial set;
(i) displaying all images of a display set on an image display screen in an identical mode, according to the parameters of a game—steps (a) and (b);
(j) sending by a player some signal to a control section through input section of said apparatus, machine or device, when a player thinks that the image is displayed on an image display screen the second time;
(k) comparing by control section of said image of step (i) with the right response or their place numbers, if said images or numbers are identical (equal), it is a successful match—the win, otherwise it is the failure;
(l) informing a player by a control section on result of a game, for example, by the different texts, video or sound fragments;
(m) executing the other necessary steps by said control section according to the result of the game.

2. The method of claim 1 wherein a database of step (d) comprises the display set lines arranged in a pre-determined parameters of a said game, in every set may be mentioned the place number original or right response to simplify a video game program and to embody the present invention in a compact video game device.

3. The method of claim 1 wherein the step (f) of an assigning the name original to an image of the initial set, always the first place number in a display set is assigned.

4. A method of claim 3 wherein a database of step (d) comprises the display set lines arranged in a pre-determined parameters of said game, to simplify a game program and to embody the present invention in a compact video game device.

5. The method of claim 3 whereat step (f) the original place is selected in a random way out of two or more initial places of a display set and the number of such initial places is selected by a player as one of the game parameters.

6. A method of claim 5 wherein displaying of the images at step (i), at least, of said initial places of a display set is accompanied by the additional means, for example, by a special framework, line, background or/and sound.

7. A video game comprising:
an image display processing apparatus, machine or device;
a control section in apparatus, machine or device that causes an image display screen to display a display set of the different images;
a memory unit in apparatus, machine or device to store the control game program for progress of the video game in accordance with the rules of a video game, a database, scores and other data;
an input section in apparatus, machine or device to be used by a player to send a signal to said control section when he or she finds the identical match for an image, displayed earlier on said screen.
